(19) United States
(12) Patent Application Publication
(10) Pub. No.: US 2024/0036859 A1
(43) Pub. Date: Feb. 1, 2024

(54) COMPUTER-IMPLEMENTED METHOD FOR VERIFYING A SOFTWARE COMPONENT OF AN AUTOMATED DRIVING FUNCTION

(71) Applicant: Robert Bosch GmbH, Stuttgart (DE)

(72) Inventors: Christian Schildwaechter, Besigheim (DE); Lukas Koenig, Grossbottwar (DE)

(21) Appl. No.: 18/353,578

(22) Filed: Jul. 17, 2023

(30) Foreign Application Priority Data
Jul. 26, 2022 (DE) 10 2022 207 616.8

(51) Int. Cl. G06F 8/71; G06F 8/35

(52) U.S. Cl. CPC G06F 8/71; G06F 8/35

(57) ABSTRACT

A computer-implemented method for verifying a software component of an automated driving function. The native program code of the software component to be verified is limited to a set of authorized operations of the programming language used, and the following steps are performed: a) translating the native program code into a model checker representation of the software component to be verified, and b) analyzing the model checker representation of the software component to be verified using a model checking method. The native program code is converted into a finite-state machine, the states and state transitions of which are one-to-one assignable to the code structure of the native program code. The model checker representation is generated on the basis of this finite-state machine, such that the code structure of the native program code is largely retained when it is translated into the model checker representation.

### CROSS REFERENCE

The present application claims the benefit under 35 U.S.C. § 119 of German Patent Application No. DE 10 2022 207 616.8 filed on Jul. 26, 2022, which is expressly incorporated herein by reference in its entirety.

### FIELD

The present invention relates to a computer-implemented method for verifying a software component of an automated driving function. The present invention further relates to a software component of the automated driving function which has been verified, and to a computer-implemented system for developing an automated driving function, comprising at least one software component which has been verified.

### BACKGROUND INFORMATION

Computer-implemented methods for verifying a software component, known as model checking methods, are described in Gerking, C., Dziwok, S., Heinzemann, C., Schäfer, W., “Domain-specific Model Checking for Cyber-physical Systems,” Proceedings of the 12^{th} Workshop on Model-Driven Engineering, Verification and Validation (MoDeVVa 2015), Ottawa, September 2015; Kwiatkowska, M., Norman, G., Sproston, J., “Probabilistic Model Checking of the IEEE 802.11 Wireless Local Area Network Protocol,” Joint International Workshop on Process Algebra and Probabilistic Methods, Performance Modeling and Verification—Process Algebra and Probabilistic Methods: Performance Modeling and Verification, p. 169-187, 2002, and König, L., Pfeiffer-Bohnen, F., Schmeck, H., “Theoretische Informatik—ganz praktisch,” De Gruyter Studium, September 2016, Chapter 2.4.

### SUMMARY

An object of the present invention is to provide an improved computer-implemented method for verifying a software component of an automated driving function.

This object may achieved by features of the present invention. Advantageous embodiments and developments of the present invention are disclosed herein.

According to the present invention, a computer-implemented method for verifying a software component of an automated driving function is provided.

According to an example embodiment of the present invention, the native program code of the software component to be verified is limited to a set of authorized operations of the programming language used, and the following steps are performed:
a) translating the native program code into a model checker representation of the software component to be verified, and
b) analyzing the model checker representation of the software component to be verified using a model checking method.

The native program code is converted into a finite-state machine, the states and state transitions of which are one-to-one assignable to the code structure of the native program code. The model checker representation is generated on the basis of this finite-state machine, such that the code structure of the native program code is largely retained when it is translated into the model checker representation.

Testing behavior planners, fusion algorithms and other control modules to determine whether they have been correctly implemented is prior art in industrial development processes. Methods such as simulation-based testing are commonly used here, although they offer no guarantee that errors will be discovered. By contrast, model checking is a general verification method for software, based on automatic formal proofs. Here, a program is translated into a model and checked for “correctness”. The term “correctness” is specified flexibly, depending on the context, but using precise mathematical formalisms (such as temporal logic formulas). Model checking analyzes all possible sequences in the program and outputs whether a given specification is met in all cases or not (and if not, in what circumstances a violation occurs). Examples of corresponding model checking tools are
Spin (spinroot.com/spin/whatispin.html)
NuSMV (nusmv.fbk.eu/)

To permit efficient model checking of existing program code (e.g., in C++, Python, etc.), the program code needs to be translated into a format that the model checker is able to use. This step is usually carried out manually by a developer. Approaches that automatically generate model checking problems are typically based on so-called domain-specific modeling languages (DSML) rather than programming languages in C++ or similar.

The method according to the present invention advantageously allows for fully automatic model checking (without user interaction) for regular programming languages too, particularly C++ program code, based on the proposed method/translation mechanism. The method is advantageously programming language-agnostic, which means that at least all standard procedural, object-oriented and functional programming languages are suitable for it. The proposed method thus offers greater flexibility than related art methods. In addition, the model checker representation is formally unambiguous, unlike conventional methods based on test scenarios. Particularly advantageously, the analysis of the software component to be verified may be carried out both with explicit model checkers such as SPIN (SPIN: Simple PROMELA Interpreter) or symbolic model checkers such as NuSMV/nuXMV, and using various formal logics, such as CTL (CTL: computation tree logic) or LTL (LTL: linear temporal logic). The present invention is thus universally and flexibly applicable.

The translation process of the present invention presented here is particularly advantageously tailored for use in the production context for safety-critical systems (which generally involve very large state spaces containing some 10²⁰ to 10³⁰ states and are thus time-consuming to verify), i.e., with a focus on:
Complete provability of requirements, where requirements indicate, for example, requirements of the driving function of an automated vehicle, e.g. that the system must deactivate on leaving the freeway, or that no overtaking on the right is permitted if the driving function is designed as an ACC function (ACC: Adaptive Cruise Control), etc. (in contrast to partial proofs, for which model checking methods are likewise available).
Applicability for a number of typical programming languages, such as C++, Python, Java, etc. In this case, the proposed method may in particular be used on existing program code.
Fully automatic tooling for continuous integration.
Explainability, i.e., user-friendly outputs at all intermediate levels for debugging, etc.

Thus, advantageously, full automation may be achieved by limiting the native program code in an appropriate way. For full automation, it is important to limit the C++/Python/. . . code to a set of authorized operations of the programming language (for example, in a simple variant, by avoiding all loop/goto/recursive structures, or, framed in positive terms, through the use of logic operators, comparative operators, arithmetic operators, statements for setting variables, known as set statements, for changing system variables for example, decision operations in the form of branching structures, e.g., if-else statements, sequence operations and a number range), which are then first converted into a finite-state machine, which forms the basis for generating the model checker representation for analysis by way of model checking methods.

In a further specific embodiment of the present invention, at least in a first step when the native program code is converted, an intermediate representation is generated which has the structure of a finite-state machine (FSM parts), in which at least part of the native program code (code part) is embedded.

This step may optionally be performed as an intermediate step. The method is fully automatically implementable and may thus be integrated into a continuous integration (CI) pipeline. The entire process from native code to model checker operates with structurally corresponding intermediate steps, where each step may be executed and tested individually, thus permitting maximum transparency and a performance gain. In addition, the intermediate steps may be visualized as they are executed, for improved usability.

In a further specific embodiment of the present invention, in at least one further step when the native program code is converted, the at least one code part of the intermediate representation is converted into FSM parts. Advantageously, this allows for fully automatic model checking, with logic structures being retained during the conversion and a performance gain being achieved.

In a further specific embodiment of the present invention, when the native program code is converted, at least one operation of the native program code is converted into at least one substate machine comprising at least two states. Here, the individual statements (code part) in one state of the FSM are broken down in the intermediate representation into individual states, such that each state then contains only one individual statement. This process is referred to below as expansion. It allows for an efficient and one-to-one traceable translation into a model checker representation.

The method according to the present invention may advantageously also be used in other safety-critical applications, such as aircraft control systems for example, provided that the software modules or components to be verified are able to be defined as FSMs. A measure here for the quality of the particular method, i.e., in this case the conversion of at least one operation of the native program code into at least one substate machine, may be the translation time or the time taken to verify the technical driving function. Often, the less time that is needed (performance gain in processing power and resources), the more suitable the method is for the problem in question, i.e., the driving function to be checked.

In a further specific embodiment of the present invention, at least one decision operation and/or at least one sequence operation of the native program code is converted into at least one substate machine comprising at least two states.

The method of the present invention is thus simple and quick to implement and facilitates transparency through the use of clear, pure FSM structures for certain operations of the native program code. Moreover, a fully automatic verification of the software component of the automated driving function is achievable in this way.

In a further specific embodiment of the present invention, when the native program code is converted, at least one program counter is assigned to at least one part of the native program code, said at least one program counter being retained on translation into the model checker representation.

The method according to the present invention may advantageously also be used in other safety-critical applications, such as aircraft control systems for example, provided that the software modules to be verified are able to be defined as FSMs.

A measure here for the quality of the particular method may be the translation time or the time taken to verify the technical driving function. Often, the less time that is needed (performance gain in processing power and resources), the more suitable the method is for the problem in question, i.e., the driving function to be checked. Moreover, a combination of the two variants, i.e., use of a program counter and generation of a substate machine, for certain operations of the native program code is possible. For example, if system variables of the native program code are not independent, the size of the states of the FSM may be managed using a type of controller.

In a further specific embodiment of the present invention, the at least one program counter is assigned only to selected operations of the native program code, particularly to statements for setting variables (set statements).

The structure of said selected operations may be identified, numbered, embedded in the FSM and translated into the model checker representation particularly easily using a program counter.

In a further specific embodiment of the present invention, the software component of the automated driving function forms an ACC function (ACC: Adaptive Cruise Control) for an automated vehicle. The ACC function includes, inter alia, distance control, lane keeping, and other subfunctions as appropriate. The method according to the present invention may advantageously be used during the design phase of the system (availability during runtime), in order to check the correctness of the driving function, e.g., the proposed ACC function, a behavior planner, or another control module, in an automated vehicle, for example. Technically advantageously, the method is not limited to the context of automated driving or to such a driving function, but may also be used in other software modules, provided that they are able to be defined as finite-state machines. The use in safety-critical applications with large state spaces, only part of which can be covered by testing alone, is especially worthwhile. This applies in particular to driver assistance systems, highly automated driving functions, robots, aircraft control systems, autonomous ships, etc. The method according to the present invention may advantageously replace parts of the test process, thus helping to save both time and money.

A software component of an automated driving function which has been verified using the aforementioned method is also provided according to the present invention.

During the development phase in particular, this offers high flexibility and ease of use.

Furthermore, according to the present invention, a computer-implemented system for developing an automated driving function is provided, comprising the aforementioned software component which has been verified using the aforementioned method.

The advantageous embodiments and developments of the present invention, as disclosed herein—except in cases of clear dependencies or incompatible alternatives, for example—may be used individually or in any combination with one another.

The properties, features and advantages of the present invention as described above and the way in which they are achieved will become clearer and more distinctly comprehensible in conjunction with the following description of exemplary embodiments, which will be explained in more detail in conjunction with the figures.

### BRIEF DESCRIPTION OF THE DRAWINGS

FIG. 1 shows a schematic diagram of a computer-implemented system for developing an automated driving function, according to an example embodiment of the present invention.

FIG. 2 shows a schematic diagram of a method for verifying a software component of an automated driving function according to a first specific embodiment of the present invention.

FIG. 3 shows a schematic diagram of a method for verifying a software component of an automated driving function according to a second specific embodiment of the present invention.

FIG. 4 shows a schematic diagram of a method for verifying a software component of an automated driving function according to a third specific embodiment of the present invention, which is based on FIGS. 2 and 3.

FIG. 4A shows an expanded schematic diagram of a section in FIG. 4.

FIG. 5 shows a schematic diagram of a method for verifying a software component of an automated driving function according to a fourth specific embodiment of the present invention, which is based on FIGS. 2 and 3.

FIG. 5A shows an expanded schematic diagram of a section in FIG. 5.

### DETAILED DESCRIPTION OF EXAMPLE EMBODIMENTS

It is noted that the figures are merely schematic in nature and are not drawn to scale. With this in mind, the size of components and elements shown in the figures may be exaggerated or reduced for ease of understanding. Moreover, it is noted that the same reference signs have been used in the figures for elements and/or components of like design.

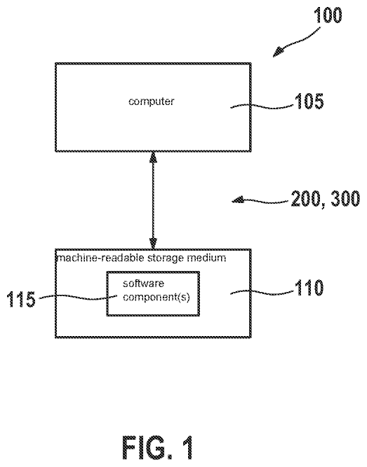

FIG. 1 shows a schematic diagram of a computer-implemented system 100, comprising a computer 105 and a machine-readable storage medium 110, said machine-readable storage medium 110 containing at least one software component 115 of an automated driving function, for example. Software component 115 comprises, as a program, commands which, when software component 115 is executed by computer 105, cause computer 105 to execute a proposed method 200, 300 for verifying software component 115. Verified software component 115 of the automated driving function may be used in a development vehicle and/or automated vehicle, for example, for the control thereof. To this end, the illustrated system 100 and components may be used in a development vehicle and/or an automated vehicle.

For example, software component 115 of the automated driving function may be designed as an ACC function for a development vehicle or automated vehicle. Additional driving functions, such as lane-keeping assistance/automation, steering assistance/automation, etc., are also possible, including in combination with one another. The ACC function may include the cited additional driving functions, for example. In the diagram in FIG. 1, machine-readable storage medium 110 is designed by way of example as an external storage medium. In an alternative embodiment, however, it may also be integrated into computer 105.

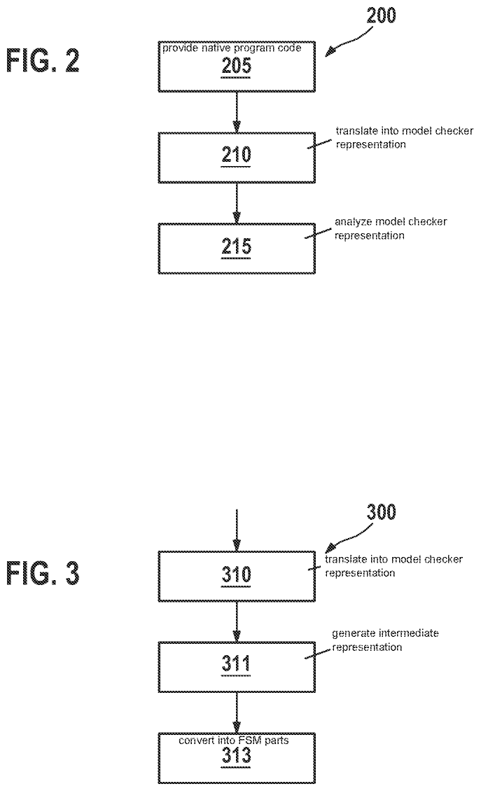

FIG. 2 shows a schematic diagram of a method for verifying a software component 115 of an automated driving function according to a first specific embodiment 200. The starting point 205 for software component 115 of the automated driving function is native program code—this may also be existing program code. For example: in the programming language C++, Python, or similar. As already mentioned above, proposed method 200 is programming language-agnostic. This native program code is already limited to a set of authorized operations of the programming language used, for example by avoiding loops and goto recursive structures, or as described above. In a first step 210 in FIG. 2, the program code is translated into a model checker representation of software component 115 to be verified and, in a second step 215, the model checker representation of the software component to be verified is analyzed using a model checking method.

First step 210 involves converting the program code into a finite-state machine (FSM), the states and state transitions of which are unambiguously assignable to the code structure of the program code. The model checker representation is generated on the basis of this FSM, such that the code structure of the native program code is largely retained when it is translated into the model checker representation. The result of the analysis of the model checker representation by way of model checking methods (probabilistic model checking, for example) in second step 215 may be, for example, proof of the correctness of software component 115 of the automated driving function or a counterproof or counterexample of correctness.

FIG. 3 shows a schematic diagram of a method for verifying a software component 115 of an automated driving function according to a second specific embodiment 300. In this case too, native program code, for example, may form the starting point for method 300, in analogy to the description of FIG. 2. Reference is made in this regard to the above description, since for redundancy reasons this is not shown in FIG. 3. In contrast to first step 210 in FIG. 2, first step 310 may comprise a first substep 311 and a second substep 313. In first substep 311, when the native program code is converted, for example, an intermediate representation is generated which has the structure of a finite-state machine, i.e., FSM parts, in which at least part of the native program code (code part) is embedded. First substep 311 is optional here and may also be omitted. If first substep 311 is executed, i.e., the intermediate representation is generated, then in at least one further step, i.e., second substep 313, when the native program code is converted, the at least one code part of the intermediate representation is converted into FSM parts.

The result of this may be, for example, that second substep 313 leads to the creation of a “pure” FSM, which no longer contains any code parts, for example. The states and state transitions of the “pure” FSM are likewise unambiguously assignable to the code structure of the native program code, so the model checker representation is likewise generated on the basis of the “pure” FSM. Thus, in this case too, the code structure of the native program code is largely retained when it is translated into the model checker representation. The analysis of the model checker representation by way of model checking methods may then be performed as described above in connection with second step 215 in FIG. 2. In an alternative embodiment, the number of substeps or method steps may be changed, for example increased or reduced, as required.

For both methods 200, 300 described above, it is always the case that, when the native program code is converted, at least one operation of the native program code is converted into at least one substate machine comprising at least two states, which the finite-state machine necessarily or conditionally assumes when the operation is executed. Particularly preferably, at least one decision operation, e.g., if-else statements, and/or at least one sequence operation, e.g., in the context of changing a variable via a set statement, of the native program code is converted into at least one substate machine comprising at least two states.

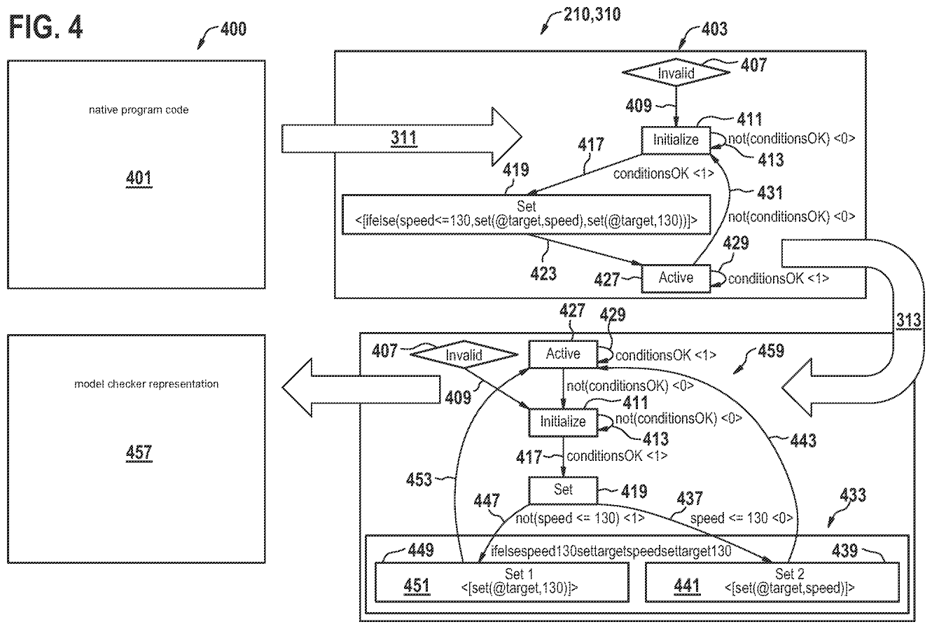

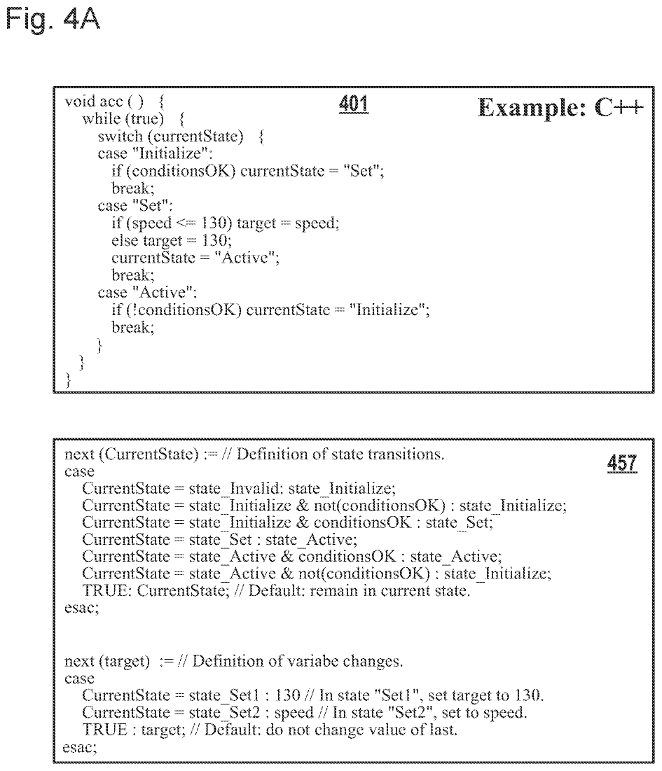

In conjunction with the aforementioned method steps and substeps, this procedure allows for a recursive execution of the conversion of the native program code or code parts into FSM parts or into a FSM, and hence for a fully automatic translation of the native program code into the specified model checker representation, including analysis thereof, i.e., including model checking. The process whereby, when the native program code is converted, at least one operation of the native program code is converted into at least one substate machine, is explained in more detail below by reference to FIG. 4.

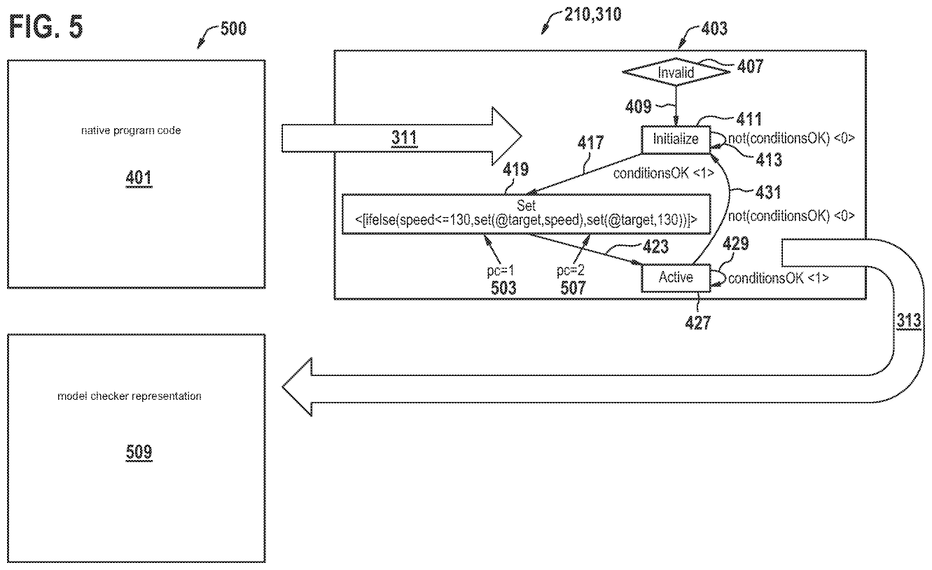

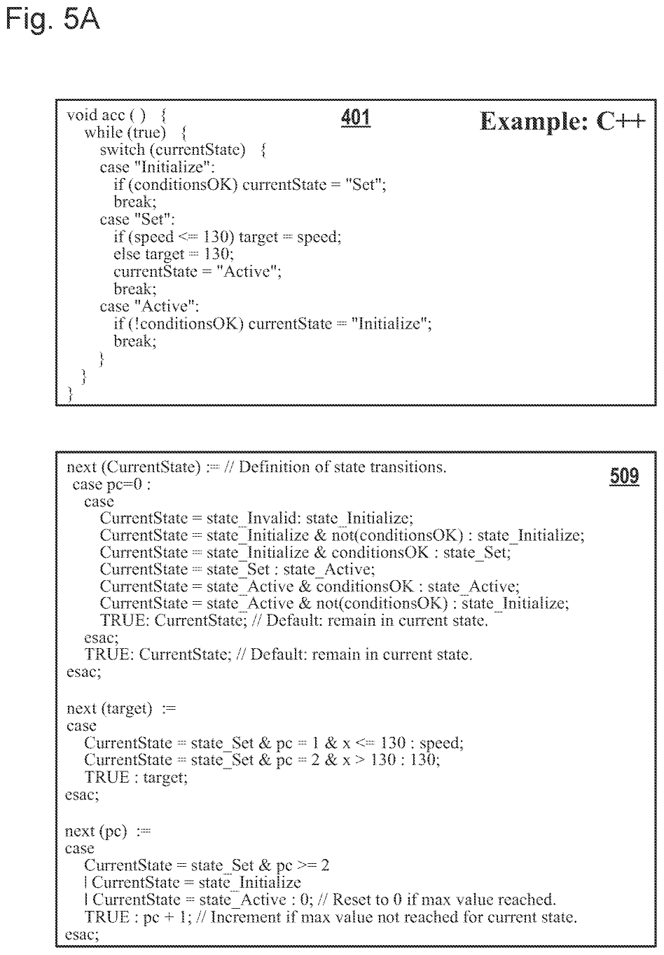

For both methods 200, 300 described above, in addition to or as an alternative to converting the at least one operation of the native program code into at least one substate machine, it is possible for at least one program counter to be assigned to at least one part of the native program code, said program counter being retained on translation into the model checker representation. The program counter is assigned only to selected operations of the native program code, particularly to statements for setting variables, known as “set statements”. The use of a program counter is described in detail by reference to FIG. 5.

FIG. 4 shows a schematic diagram of a method for verifying a software component of an automated driving function according to a third specific embodiment 400, which is based on FIGS. 2 and 3. Native program code 401, for example C++ code, forms the starting point for method 400. By way of example, this program code 401 is shown in expanded form in FIG. 4A. This corresponds to starting point 205 in FIG. 2. Native program code 401 is already limited to a set of authorized operations of the programming language used—in this case C++—by avoiding loops and goto recursive structures, for example, as described above. Alternatively, program code in any other programming language is also possible, because, as mentioned above, the proposed method is programming language-agnostic. Program code 401 may be existing program code and may be structured as follows, for example:

```
void acc ( ) {
  while (true) {
    switch (currentState) {
    case “Initialize”:
        if (conditionsOK) currentState = “Set”;
        break;
    case “Set”:
        if (speed <= 130) target = speed;
        else target = 130;
        currentState = “Active”;
        break;
    case “Active”:
    if (!conditionsOK) currentState = “Initialize”:
    break;
    }
  }
}
```

Program code 401 comprises a simplified ACC driving function (ACC: Adaptive Cruise Control) for an automated vehicle as software component 115 to be verified, and may include, inter alia, distance control, lane keeping, and other subfunctions as appropriate in the context of the ACC driving function. For example, “conditionsOK”, “speed” and “target” each correspond to variables or system variables. The terms variable and system variable are used synonymously below. In program code 401, the target system variable is set to the value of the speed system variable, provided that the system variable does not exceed the maximum value 130, otherwise the value is set to 130. FIG. 4 shows in detail first step 210, 310 of FIGS. 2 and 3, respectively, in other words the translation of native code 401 into a model checker representation 457 of software component 115 to be verified, in particular including first and second substep 311, 313 of FIG. 3. In first substep 311 in FIG. 4, when native program code 401 is converted, an intermediate representation 403 is generated which has the structure of a finite-state machine (FSM parts), in which at least part of native program code 401 is embedded. Intermediate representation 403 with the FSM parts has a state space containing states which are interconnected by way of state transitions.

Rather than state transitions with transition conditions, reference is often also made to edges and edge conditions for setting the states. In this case, states correspond to outputs and state transitions to inputs. The states and state transitions are described with the aid of system variables/variables and the set of operations which, as explained above, have already been defined as being permissible for the corresponding programming language.

Intermediate representation 403 includes a start state 407, “Invalid”. This takes the form of an invalid start state 407, for example, after which the program immediately jumps via a first state transition 409, which is always true (corresponds to the Boolean value “true” or 1), to a second state 411. Second state 411, “Initialize”, corresponds to the first case, “Initialize”, in program code 401, for example. In second state 411, “Initialize”, for example, no changes are made to system variables/variables; instead, the program merely waits for a signal from the “conditionsOK” system variable/variable, which at the same time forms a condition for a second state transition 417 to a third state 419, for example.

Second state transition 417 comprises, for example, a state transition condition with a priority, which priority allows an execution sequence of the state transitions to be defined. For example, the highest priority may be set to the value zero, the priorities then decreasing as the value rises. In addition, the priority may also be assigned to a first hold condition 413, “not(conditionsOK) <0>”, of second state 411 (in this case the priority <0>). In the example shown, if first hold condition 413 is true (i.e., no signal from the “conditionsOK” system variable present), then the effect of hold condition 413 may be that state transition 417 is not executed, because the priority <0> of hold condition 413 is higher than the priority <1> of state transition 417.

The program thus waits in state 411 until hold condition 413 is no longer fulfilled and the state transition condition of transition 417 is fulfilled instead, i.e., a signal from said system variable is present. Third state 419 may be designed as a “Set” state, for example, and include statements for setting/changing variables/system variables. State 419 may correspond to the second case of program code 401.

“Set” state 419 directly triggers the change of variables/system variables with the aid of set statements. In the example shown, set state 419 includes remaining program code in the form of an if-else branching structure (in C++ notation):
if (speed<=130) target=speed;
else target=130;

This remaining program code is converted with the aid of two set statements (set operators), i.e., the system variable change of the if branch with the first set statement and the system variable change of the else branch with the second set statement ([ifelse (speed<=130, set(@target, speed), set(@target, 130))]). From “Initialize” state 411, it would be possible in “Set” state 419 to jump to one of two different set statements, depending on whether speed<=130 or speed>130 is true. Here, one set statement sets the value of target to the value of speed, and the other set statement sets the value to 130. In particular, set state 419 itself makes a decision (decision operation, see above), which may take place at the pure FSM level.

In addition to typical finite-state machine elements (such as the states “Initialize” 411, “Set” 419 and “Active” 427 and the individual state transitions with state transition conditions or activation conditions), intermediate representation 403 also includes program code, for example the remaining code part in “Set” state 419, as explained above.

After executing set state 419, a fourth state 427 is set via a third state transition 423 with an always-true transition condition (1). Fourth state 427 is designed as an “Active” state, for example, and corresponds to the “Active” case of program code 401 above. “Active” state 427 may also be designed in a similar way to “Initialize” state 411, for example, and involve no system variable change, but once again comprise an expected signal from the “conditionsOK” system variable. In contrast to “Initialize” state 411, for example, a fourth state transition 431 may in this case have a higher priority (<0>) in the not(conditionsOK) state transition condition, i.e., no signal from the conditionsOK system variable is present, than a second hold condition 429, conditionsOK, with priority <1>, i.e. a signal from said variable is present. If the state transition condition is fulfilled, then fourth state transition 431 leads back to “Initialize” state 411. The explanation above in respect of state 411 then applies once more.

First substep 311 of method 400 in FIG. 4 is followed by second substep 313, namely the conversion of the remaining code part of intermediate representation 403 into FSM parts, in such a way that second substep 313 leads to the creation of a “pure” FSM which no longer contains any code parts and corresponds to a pure FSM 459. To this end, second substep 313 comprises in particular the creation of at least one substate machine 433. In the example shown in FIG. 4, one substate machine 433 has been generated. Substate machine 433 or the lower-level FSM corresponds to a hierarchical substructure, for example, and in the example shown comprises two states 439, 449. In this case, substate machine 433 is generated in particular for “Set” state 419 in FIG. 4, because, as mentioned above, “Set” state 419 comprises two statements for changing variables, in other words two set statements.

This is an exemplary example and may also be implemented in different ways in alternative embodiments; in particular, additional states or outputs may be broken down or expanded into substate machines, such that each state or each output comprises just one action or just one statement. In particular, the recursive execution of the conversion of certain operations of the program code into at least one substate machine 433 having at least two states may be easily implemented in this way, in order to generate a pure FSM 459 and, on the basis thereof, model checker representation 457.

A first state transition 437 of substate machine 433 with the higher priority <0> may include, for example, the associated transition condition speed<=130 (e.g., the Boolean value of the if-else statement in program code 401). If transition condition 437 of the first state transition of substate machine 433 is true, then the program jumps to a first state 439 of substate machine 433 and executes a first action of lower-level FSM 441, i.e., the change of the value of the target system variable to the value of the speed system variable via an individual set statement. This corresponds, for example, to the if branch of the if-else statement of program code 401 or to the part of intermediate form 403 that is linked to this process via a set statement. The program jumps to “Active” state 427 via a second state transition 443 of substate machine 433, which is always true (1). In this way, state 427 following on from higher-level state 419 is taken into account and may be reached by way of new state transition 443, such that the logic structure, despite the formation of a substate machine, is retained.

A second state transition 447 of substate machine 433 with the lower priority <1> may include, for example, the associated transition condition not(speed<=130), i.e., the negation of the transition condition of state transition 437. If the transition condition of transition 447 is true, then the program jumps to a second state 449 of substate machine 433 to execute a second action 451 of the substate machine, i.e., the change of the value of the target system variable to the value 130 via a further individual set statement. This corresponds to the else branch of the if-else statement in program code 401, for example, or to the part of the intermediate form, i.e. finite-state machine 403, that is linked to this process via an output operator. The program jumps to “Active” state 427 via a third state transition of lower-level FSM 453, which is always true (1). In this way, state 427 following on from higher-level state 419 is taken into account and may be reached by way of new state transition 453, such that the logic structure, despite the formation of a substate machine 433, is retained.

This results in a pure FSM 459 which, at each state or each output, as mentioned above, now comprises just one action, e.g., in the form of a set statement for changing system variables/variables. The process of forming substate machine 433 may also be described as expanding program code 401 or resolving program code 401.

In the example shown, model checker representation 457 is generated on the basis of the pure FSM 459 structure, such that the code structure of native program code 401 is largely retained when it is translated into model checker representation 457. The nuSMV tool and CTL logic, for example, may be used for this (alternative tools are also possible, as described above). An expanded view of model checker representation 457 is shown in FIG. 4A, for example. The declaration and initialization of the variables are omitted here, and model checker representation 457 may be implemented as follows:

```
next(CurrentState) := // Definition of state transitions. >
case
  CurrentState = state_Invalid : state_Initialize;
  CurrentState = state_Initialize & not(conditionsOK) :
  state_Initialize;
  CurrentState = state_Initialize & conditionsOK: state_Set;
  CurrentState = state_Set : state_Active;
  CurrentState = state_Active & conditionsOK : state_Active;
  CurrentState = state_Active & not(conditionsOK) :
  state_Initialize;
  TRUE: CurrentState; // Default: remain in current state.
esac
next(target) := // Definition of variable changes.
case
CurrentState = state_Set1 : 130; // In State “Set1”, set target
to 130.
CurrentState = state_Set2 : speed; // In state “Set2”, set to
speed.
TRUE : target; // Default: do not change value of last.
esac;
```

The state transitions may be implemented by a “CurrentState” variable, which (in the top “case”-“esac” block) changes its value according to the transitions of intermediate representation 403 with substate machine 433. A “case”-“esac” block is also created for each additional variable, providing for a corresponding change for each state in which the variable is set. To enable the functionality of the original intermediate representation 403 to be reproduced exactly in terms of the temporal sequence too, the “atomicity” of the original code parts 401 has been established. This means that the operations that were previously executed in one step in program code 401 also require one step in the expanded version, i.e., in the pure FSM 459. In this way, it is possible for the code structure of native code 401 to be largely retained in the translation process presented here (i.e., methods 200, 300).

For instance, pure FSM 459 in the example performs one more transition than intermediate representation 403, comprising FSM parts and code parts, when setting the “target” system variable. At the level of intermediate representation 403, this may be achieved by executing substate machine 433 together with previous set state 419 in one (temporal) step. At a model checker level, auxiliary variables which generate this effect may be introduced. For example: the program counter described in more detail in FIG. 5, which may be additionally or alternatively introduced in order to form a substate machine 433.

Finally, the model checker representation 457 presented here is also analyzed using a model checking method, in other words model checking is performed on the basis of model checker representation 457.

FIG. 5 shows a schematic diagram of a method for verifying a software component of an automated driving function according to a fourth specific embodiment 500, which is based on FIGS. 2 and 3. As with method 400 in FIG. 4, native program code 401, for example C++ code, forms the starting point for method 500. Program code 401 is shown in expanded form in FIG. 5A. This corresponds to starting point 205 in FIG. 2. Since method 500 in FIG. 5 is similar to method 400 in FIG. 4, only the differences from FIG. 4 are explained in more detail below. In contrast to FIG. 4, method 500 includes the assignment of at least one program counter “pc” (or a count variable) to at least one part of native program code 401 when the native program code is converted. FIGS. 4 and 5 may be combined in order to implement a combination of formation of a substate machine and use of a program counter. The program counter “pc” comprises various values (“pc”=1, 503 and “pc”=2, 507), each of which is assigned to an individual action, an action corresponding to a value of the program counter.

In the specific exemplary embodiment in FIG. 5, the program counter “pc” is introduced for the remaining program code part of “Set” state 419 with associated actions 421, specifically the set operators as output operators:

```
if (speed <= 130) {
  target = speed; // Corresponds to “pc” = 1 in the proposed
  method.
else {
  target = 130; / / Corresponds to “pc” = 2 in the proposed
  method.
}
```

Here, for example, the if branch corresponds to the value “pc”=1, 503 of the count variable and the else branch of the branching structure corresponds to the value “pc”=2, 507 of the count variable.

Therefore, for the aforementioned code part, proposed method 500 introduces the program counter “pc”, which in method 500 (and in methods 200, 300, 400 in the previous figures) keeps track of which point has been reached in the code (the count variable “pc” thus reproduces the line execution logic of program code 401 of a program). In contrast to common program counter approaches (approaches for count variables), in machine languages for instance, the count variable “pc” in this case is assigned only to the set statements, since the more efficient model checker logic may be used for the other operations. Thus, in the example, the values pc=1, 503 and pc=2, 507 of the program counter are assigned to the two set statements set(@target, speed) “target=speed” and set(@target, 130) “target=130”, for example, which are part of program code 401 of the “state Set” state. If “Set” state 419 in FIG. 5 were also to include other set statements for changing system variables, then the program counter might correspondingly include additional values reflecting the individual set statements.

Second substep 313 in FIG. 5 may then be designed in analogy again to the descriptions relating to FIG. 4, i.e., for conversion/translation of intermediate representation 403 with program counter “pc” into a model checker representation 509. Model checker representation 509 is shown in expanded form in FIG. 5A, for example. Model checker representation 509 may have been created in a similar way to model checker representation 457 in FIG. 4, for example, and may include the following logic:

```
next (CurrentState) := // Definition of state transitions.
case pc=0 :
  case
    CurrentState = state_Invalid : state_Initialize;
    CurrentState = state_Initialize & not (conditionsOK) :
    state_Initialize;
    CurrentState = state_Initialize & conditionsOK: state_Set;
    CurrentState = state_Set : state_Active;
    CurrentState = state_Active & conditionsOK : state_Active;
    CurrentState = state_Active & not (conditionsOK) :
    state_Initialize;
    TRUE: CurrentState; // Default: remain in current state.
  esac;
  TRUE: CurrentState; // Default: remain in current state.
  esac;
next (target) : =
case
CurrentState = state_Set & pc = 1 & x <= 130 : speed;
CurrentState = state_Set & pc = 2 & x > 130 : 130;
TRUE : target;
esac;
next (pc) :=
case
CurrentState = state_Set & pc >= 2
| CurrentState = state_Initialize
| CurrentState = state_Active : 0; // Reset to 0 if max value
reached.
TRUE : pc + 1; // Increment if max value not reached for current state.
esac;
```

In model checker representation 509, the logic of the if-else branching structure with the program counter is represented by
CurrentState=state Set & pc=1 & x<=130: speed;
CurrentState=state Set & pc=2 & x>130: 130;
   in the middle “next(target)” block. In this way, structures that satisfy the above limitations, no matter how complex they are, may first be numbered and then converted into the structure shown.

Lastly, the program counter “pc” has to be incremented separately for each state or each output, and for the actions or statements or operations contained therein, via the statement

CurrentState = state_Set & pc >= 2
| CurrentState = state_Initialize
| CurrentState = state_Active : 0; // Reset to 0 if max value
reached.
TRUE : min(2, pc + 1);

in the bottom “next(pc)” block. This means that the values of the program counter “pc” are incremented accordingly to execute the individual actions/statements/operations of state 419. In the example shown in FIG. 5, the program counter “pc” in “state Set” is incremented to two, set to 507 (corresponds in this case to the maximum value, for example) and then set to the value 0 (zero) (once the maximum value has been reached and all actions/statements/operations have been executed). This results in a continuation of the “CurrentState” in the next step. There are no set statements in the other states in the example, so no incrementation occurs there, and computation of the “CurrentState” system variable continues immediately.

In model checker representation 509, the FSM part of intermediate representation 403 corresponds to the top “next(CurrentState)” block. Note here the difference between “pc=0” and “pc !=0” in the outer case, which has the effect that the “CurrentState” state (in original intermediate representation 403) is only changed once the code part in the corresponding state has been executed. Finally, model checker representation 509 presented here is analyzed using a model checking method.

Special treatment is necessary if a structure such as that given below is present in native program code 401 (in C++ notation, A and B are statements, only the if branch is shown, but an else branch may also be present):

```
if (c) {
  [ . . . ]
    A; // A changes the Boolean value of c to false. For
    example, A = “c = false”;
    B; // == > B and [ . . . ] drop out during model
    checking, see below.
  [ . . . ]
}
```

The special case applies if a statement A changes system variables in such a way that, in an enclosing if-then-else block, the associated if condition c is no longer true. With the method described above, a statement B following A in the model checking would then no longer be executed, because condition c is assigned to each individual statement (and not to the entire block). Therefore, after executing A, c in the next step would no longer be true, and B would not be executed. This may be avoided by preprocessing the code to eliminate the problematic structure. Thus, the above code could be replaced by:

```
temp = c;
if (temp) {
  [ . . . ]
    A; // A sets c to false, but temp is not affected.
    B; // B and [ . . . ] are still executed.
  [ . . . ]
}
```

In summary, this means that if the remaining subset of operations includes a branching structure with a Boolean value c (i.e., the remaining program code in intermediate representation 403 or native program code 401 contains such an if branching structure) in which the Boolean value c is changed by an action in the state (e.g., by an executable statement A in the example above), then an additional “temp” auxiliary variable is introduced. The effect of the additional “temp” auxiliary variable is that even if c is changed, the Boolean value “temp” inside the if branch of the branching structure is not affected, and the if branch would still be executed and would not result in termination.

The present invention has been described in detail by way of preferred exemplary embodiments. Other exemplary embodiments, which may include further variations or combinations of described features, are also possible instead of the exemplary embodiments described. For that reason, the present invention is not limited by the disclosed examples, since a person skilled in the art may deduce other variations therefrom without leaving the scope of protection of the present invention.

What is claimed is:

1. A computer-implemented method for verifying a software component of an automated driving function, native program code of the software component to be verified being limited to a set of authorized operations of the programming language used, the method comprising the following steps:
translating the native program code into a model checker representation of the software component to be verified; and
analyzing the model checker representation of the software component to be verified using a model checking method;
wherein in the translating, the native program code is converted into a finite-state machine, states and state transitions of which being one-to-one assignable to the code structure of the native program code, and the model checker representation is generated based on the finite-state machine, such that a code structure of the native program code is largely retained when it is translated into the model checker representation.

2. The method as recited in claim 1, wherein, when the native program code is converted, an intermediate representation is generated which has a structure of the finite-state machine, in which at least one code part of the native program code is embedded.

3. The method as recited in claim 2, wherein, when the native program code is converted, the at least one code part of the intermediate representation is converted into parts of the finite-state machine.

4. The method as recited in claim 1, wherein, when the native program code is converted, at least one operation of the native program code is converted into at least one substate machine including at least two states.

5. The method as recited in claim 4, wherein at least one decision operation and/or at least one sequence operation of the native program code is converted into at least one substate machine include at least two states.

6. The method as recited in claim 1, wherein, when the native program code is converted, at least one program counter is assigned to at least one part of the native program code, and the at least one program counter is retained on translation into the model checker representation.

7. The method as recited in claim 6, wherein the at least one program counter is assigned only to selected operations of the native program code including statements for setting variables.

8. The method as recited in claim 1, wherein the software component of an automated driving function forms an ACC function for an automated vehicle.

9. A software component of an automated driving function, which has been verified by:
translating the native program code into a model checker representation of the software component to be verified; and
analyzing the model checker representation of the software component to be verified using a model checking method;
wherein in the translating, the native program code is converted into a finite-state machine, states and state transitions of which being one-to-one assignable to the code structure of the native program code, and the model checker representation is generated based on the finite-state machine, such that a code structure of the native program code is largely retained when it is translated into the model checker representation.

10. A computer-implemented system for developing an automated driving function, comprising:
at least one software component which has been verified by:
translating the native program code into a model checker representation of the software component to be verified, and
analyzing the model checker representation of the software component to be verified using a model checking method,
wherein in the translating, the native program code is converted into a finite-state machine, states and state transitions of which being one-to-one assignable to the code structure of the native program code, and the model checker representation is generated based on the finite-state machine, such that a code structure of the native program code is largely retained when it is translated into the model checker representation.
